(19) United States
(12) Patent Application Publication
(10) Pub. No.: US 2023/0326257 A1
(43) Pub. Date: Oct. 12, 2023

(54) HYDROGEN SUPPLY SYSTEM, RESERVATION DEVICE, RESERVATION METHOD, AND STORAGE MEDIUM

(71) Applicant: HONDA MOTOR CO., LTD., Tokyo (JP)

(72) Inventors: Satoru Shinzaki, Wako-shi (JP); Takashi Arai, Wako-shi (JP); Naoki Yamano, Wako-shi (JP)

(21) Appl. No.: 18/109,280

(22) Filed: Feb. 14, 2023

(30) Foreign Application Priority Data
Mar. 24, 2022 (JP) 2022-047829

(51) Int. Cl. G07C 5/00; G06Q 10/02; H01M 8/04082; F17C 13/02

(52) U.S. Cl. CPC G07C 5/004; F17C 13/02; G06Q 10/02; G07C 5/008; H01M 8/04201; B60S 5/02; F17C 2201/056; F17C 2221/012; F17C 2250/0417; F17C 2250/0694; F17C 2270/0178; F17C 2270/0184; H01M 2250/20

(57) ABSTRACT

A hydrogen supply system includes: a facility identification unit that identifies a fuel supply facility in the vicinity of a travel route of a vehicle to a destination; a calculation unit that calculates an estimated remaining amount of hydrogen fuel at an arrival time when the vehicle reaches the fuel supply facility on the basis of remaining amount information indicating a remaining amount of the hydrogen fuel transmitted from the vehicle; a determination unit that determines whether or not refueling of the vehicle is required on the basis of the estimated remaining amount; and a registration unit that registers an estimated replenishment amount based on the estimated remaining amount and the arrival time as a usage reservation at the fuel supply facility in a case in which the determination unit determines that the refueling is required.

### CROSS-REFERENCE TO RELATED APPLICATION

Priority is claimed on Japanese Patent Application No. 2022-047829, filed Mar. 24, 2022, the content of which is incorporated herein by reference.

### BACKGROUND OF THE INVENTION

### Field of the Invention

The present invention relates to a hydrogen supply system, a reservation device, a reservation method, and a storage medium.

### Description of Related Art

In recent years, in order to reduce a negative impact on the global environment, regulations on automobile exhaust gases have progressed further. For this reason, for example, fuel cell vehicles using fuel cells are becoming popular. Fuel cell vehicles run using a driving force of a motor that is driven using electrical energy generated by a chemical reaction between hydrogen and oxygen. Hydrogen fuel is used as fuel for fuel cell vehicles. Hydrogen fuel is generated in a hydrogen station and supplied to fuel cell vehicles. For this reason, a user of a fuel cell vehicle goes to a hydrogen station to refill the fuel cell vehicle with hydrogen fuel.

In related techniques, a technique in which, for the purpose of shortening the time required to start filling hydrogen gas in a hydrogen station, a request for performing preprocessing for filling a hydrogen gas storage unit of a fuel cell vehicle with hydrogen gas is made to the hydrogen station has been disclosed (for example, see Japanese Unexamined Patent Application, First Publication No. 2021-110547).

### SUMMARY OF THE INVENTION

However, in known techniques, there are cases in which a driver cannot make a reservation for refueling while driving, or cannot know in advance what amount of supply of hydrogen fuel is required at a hydrogen station. Thus, when the hydrogen fuel is replenished, congestion may occur due to waiting for replenishment, or there may be a shortage of the hydrogen fuel supplied. For this reason, in known techniques, there are cases in which replenishment and provision of the hydrogen fuel cannot be performed efficiently.

Aspects of the present invention have been made in consideration of such circumstances, and an object thereof is to provide a hydrogen supply system, a reservation device, a reservation method, and a storage medium in which replenishment and provision of hydrogen fuel can be performed efficiently.

In order to solve the above problems and achieve the object, the present invention adopts the following aspects.

A hydrogen supply system according to an aspect of the present invention includes: a facility identification unit that identifies a fuel supply facility in the vicinity of a travel route of a vehicle to a destination; a calculation unit that calculates an estimated remaining amount of hydrogen fuel at an arrival time when the vehicle reaches the fuel supply facility on the basis of remaining amount information indicating a remaining amount of the hydrogen fuel transmitted from the vehicle; a determination unit that determines whether or not refueling of the vehicle is required on the basis of the estimated remaining amount; and a registration unit that registers an estimated replenishment amount based on the estimated remaining amount and the arrival time as a usage reservation at the fuel supply facility in a case in which the determination unit determines that the refueling is required.

In the above aspect (1), a user terminal device associated with the vehicle may be provided, a transmission unit that transmits usage reservation information indicating the usage reservation registered by the registration unit to the user terminal device may be provided, and the user terminal device may output the usage reservation information.

In the above aspect (1) or (2), the usage reservation may include vehicle identification information that identifies the vehicle, and a permission unit that permits the refueling of the vehicle on the basis of the vehicle identification information included in the usage reservation and the vehicle identification information obtained when the vehicle reaches the fuel supply facility may be provided.

A reservation device according to an aspect of the present invention includes: a facility identification unit that identifies a fuel supply facility in the vicinity of a travel route of a vehicle to a destination; a calculation unit that calculates an estimated remaining amount of hydrogen fuel at an arrival time when the vehicle reaches the fuel supply facility on the basis of remaining amount information indicating a remaining amount of the hydrogen fuel transmitted from the vehicle; a determination unit that determines whether or not refueling of the vehicle is required on the basis of the estimated remaining amount; and a registration unit that registers an estimated replenishment amount based on the estimated remaining amount and the arrival time as a usage reservation at the fuel supply facility in a case in which the determination unit determines that the refueling is required.

A reservation method according to an aspect of the present invention causes a computer used in a hydrogen supply system to execute processing including: identifying a fuel supply facility in the vicinity of a travel route of a vehicle to a destination; calculating an estimated remaining amount of hydrogen fuel at an arrival time when the vehicle reaches the fuel supply facility on the basis of remaining amount information indicating a remaining amount of the hydrogen fuel transmitted from the vehicle; determining whether or not refueling of the vehicle is required on the basis of the estimated remaining amount; and registering an estimated replenishment amount based on the estimated remaining amount and the arrival time as a usage reservation at the fuel supply facility in a case in which it is determined that the refueling is required.

A computer-readable non-transitory storage medium according to an aspect of the present invention stores a program that executes processing in a computer used in a hydrogen supply system, the processing including: identifying a fuel supply facility in the vicinity of a travel route of a vehicle to a destination; calculating an estimated remaining amount of hydrogen fuel at an arrival time when the vehicle reaches the fuel supply facility on the basis of remaining amount information indicating a remaining amount of the hydrogen fuel transmitted from the vehicle; determining whether or not refueling of the vehicle is required on the basis of the estimated remaining amount; and registering an estimated replenishment amount based on the estimated remaining amount and the arrival time as a usage reservation at the fuel supply facility in a case in which it is determined that the refueling is required.

According to (1) to (6), replenishment and provision of the hydrogen fuel can be performed efficiently.

### BRIEF DESCRIPTION OF THE DRAWINGS

FIG. 1 is a diagram showing a configuration of a hydrogen supply system according to an embodiment.

FIG. 2 is a block diagram showing an example of a hardware configuration of a fleet management server.

FIG. 3 is a block diagram showing an example of a functional configuration of the hydrogen supply system.

FIG. 4 is a diagram showing an example of information stored in a vehicle management DB.

FIG. 5 is a diagram showing an example of information stored in a reservation DB.

FIG. 6 is a flowchart showing an example of reservation processing in the hydrogen supply system.

FIG. 7 is a flowchart showing an example of replenishment processing performed by a hydrogen station server.

### DETAILED DESCRIPTION OF THE INVENTION

Embodiments of a hydrogen supply system, a reservation device, a reservation method, and a storage medium according to the present invention will be described below with reference to the drawings.

### Configuration of Hydrogen Supply System 1

FIG. 1 is a diagram showing a configuration of a hydrogen supply system 1 according to an embodiment. In FIG. 1, the hydrogen supply system 1 includes a fleet management server 100, a hydrogen station server 110, vehicles 120 (120-1 to 120-n), and user terminal devices 130 (130-1 to 130-n). The devices are communicably connected to each other via a network 140. The fleet management server 100, the hydrogen station server 110, the vehicles 120 (information processing devices provided in the vehicles 120), and the user terminal devices 130 each include a central processing unit (CPU), a read only memory (ROM), a random access memory (RAM), a communication unit, and the like.

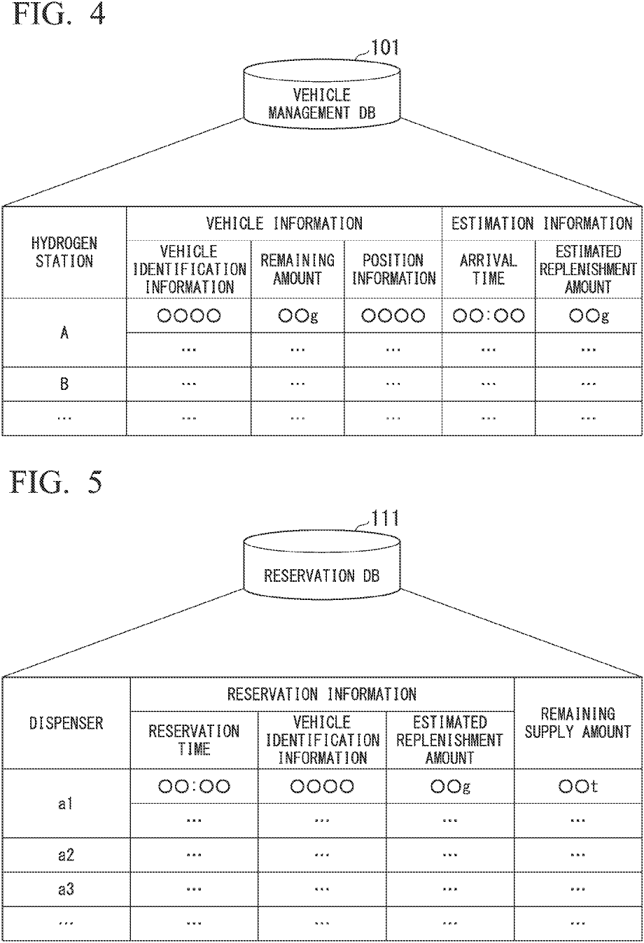

The fleet management server 100 manages information on various services provided by fleet management companies. Specifically, the fleet management server 100 manages a current position and a travel history of a pre-registered vehicle 120, a remaining amount of fuel, a cost of fuel, and the like and plans promotion of safe driving, improvement of operational efficiency, and the like. The fleet management server 100 includes a vehicle management database (DB) 101. Although the details will be described later with reference to FIG. 4, the vehicle management DB 101 stores a remaining amount of hydrogen fuel of each vehicle 120, position information of each vehicle 120, and the like.

The hydrogen station server 110 manages a supply amount of hydrogen fuel at a hydrogen station and a reservation of the vehicle 120 for replenishment. The hydrogen station is an example of a fuel supply facility. The hydrogen station is a facility for supplying hydrogen fuel, which includes a hydrogen fuel generation device, a pressure accumulator, a dispenser, and the like. The hydrogen station is disposed, for example, in a truck yard in which commercial trucks unload and transship cargo. For example, it is assumed that a hydrogen station is provided for each predetermined area, that is, a plurality of hydrogen stations are provided.

The hydrogen fuel generation device uses electric power from renewable energy such as solar power and wind power to electrolyze water and generate hydrogen fuel. For this reason, if an amount of a surplus of the hydrogen fuel generated is too much as compared to the hydrogen fuel supplied to the vehicle, losses relating to work and processes required for water electrolysis may occur, and energy may not be utilized efficiently. The hydrogen fuel generation device may generate hydrogen fuel by steam reforming city gas (methane) or liquefied petroleum gas (LPG).

The accumulator stores hydrogen fuel. The dispenser includes a nozzle and a control panel for filling the vehicle 120 with hydrogen fuel, monitors a flow rate and a temperature, and measures a filling amount. The nozzle is configured to engage with a receptacle of the vehicle 120 and is structured not to come off until decompressed even after refilling.

For each hydrogen station, the hydrogen station server 110 manages a production amount of hydrogen fuel generated by the hydrogen fuel generation device and an amount of hydrogen fuel stored in the pressure accumulator, and manages an amount of hydrogen fuel discharged from the dispenser. The hydrogen station server 110 includes a reservation DB 102. Although the details will be described later with reference to FIG. 5, the reservation DB 102 stores reservation information relating to replenishment of hydrogen fuel for each vehicle 120, and the like. The hydrogen station can provide hydrogen fuel not only to the vehicles 120 registered with the fleet management server 100 but also to unregistered general vehicles.

The vehicles 120 are fuel cell vehicles. In the present embodiment, the vehicles 120 are ordinary automobiles (for example, commercial 2-ton trucks), but may be large automobiles, two-wheeled vehicles, three-wheeled cars, sidecars, or the like. For convenience of explanation, an amount of hydrogen fuel when a fuel tank is full is uniformly assumed to be 5000 g (125 liters), for example. The amount of hydrogen fuel will be described below in terms of weight (g), but it can also be expressed in terms of volume (liters).

The vehicle 120 includes a detection unit that detects a remaining amount of hydrogen fuel. The vehicle includes a Global Positioning System (GPS) unit that detects position information of the vehicle itself. The vehicle 120 includes an information processing device such as a navigation device and periodically transmits the remaining amount of hydrogen fuel and position information indicating its current position to the fleet management server 100.

The user terminal device 130 is a terminal device owned by a driver (user) of the vehicle 120. The user terminal device 130 is, for example, a smart phone. A reservation application (application software) relating to the fleet management server 100 is installed in the user terminal device 130. The user terminal device 130 is associated with the vehicle 120 and registered with the fleet management server 100. For this reason, the number of user terminal devices 130 (130-1 to 130-n) is, for example, approximately the same as the number of registered vehicles 120 (120-1 to 120-n).

The user terminal device 130 receives various registrations in the reservation application. The various registrations include, for example, membership registration, registration for associating the vehicle 120 with its own terminal, registration of card information of a credit card, and the like. Various registered content is registered in the fleet management server 100, the hydrogen station server 110, an external device (for example, a credit card server), and the like. The user terminal device 130 uses the card information of the credit card registered in the reservation application to receive payment according to replenishment of hydrogen fuel.

### Hardware Configuration of Fleet Management Server 100

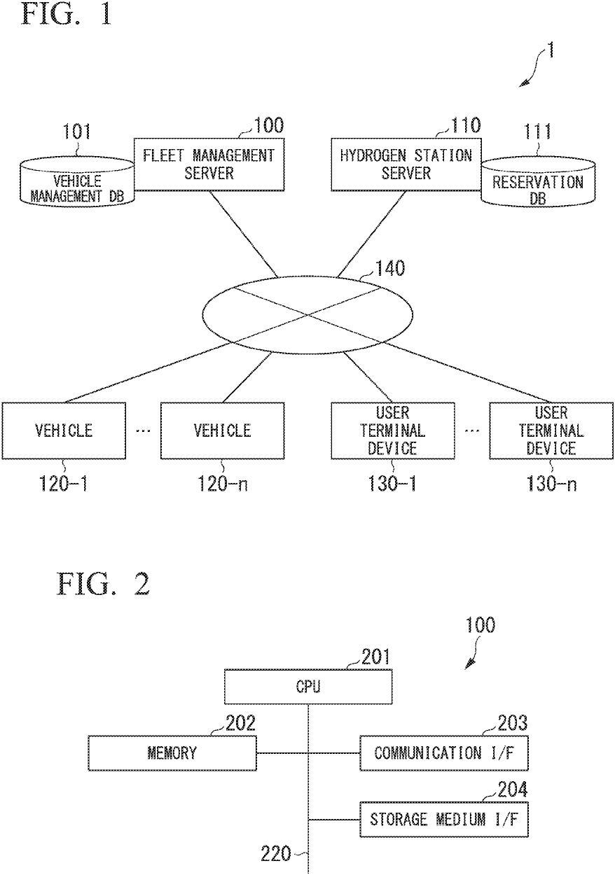

FIG. 2 is a block diagram showing an example of a hardware configuration of the fleet management server 100. Although the illustration is omitted, a hardware configuration of the hydrogen station server is similar to that of the fleet management server 100.

In FIG. 2, the fleet management server 100 includes a CPU 201, a memory 202, a communication I/F 203, and a storage medium interface (I/F) 204. The constituent parts 201 to 204 are connected to each other by a bus 220.

The CPU 201 takes charge of overall control of the fleet management server 100. The memory 202 has, for example, a ROM, a RAM, a flash ROM, and the like. For example, the flash ROM or the ROM stores various programs. The various programs include a reservation program according to the present embodiment. The RAM is used as a work area for the CPU 201. Programs stored in the memory 202 are loaded into the CPU 201 to cause the CPU 201 to execute coded processing. The memory 202 stores the vehicle management DB 101.

The communication I/F 203 is connected to the network 140 such as the Internet through a communication line and is connected to other devices (for example, the hydrogen station server 110, the vehicles 120, the user terminal device 130, and the like) via the network 140. A communication I/F 203 serves as an interface between the network 140 and the inside of the own device and controls input and output of data from other devices.

In accordance with control of the CPU 201, the storage medium I/F 204 controls reading and writing of data to a storage medium (not shown) such as a magnetic disk or an optical disc.

The fleet management server 100 may include input devices such as a keyboard, a mouse, and a touch panel. The fleet management server 100 may include output devices such as a display and a speaker.

### Functional Configuration of Hydrogen Supply System 1

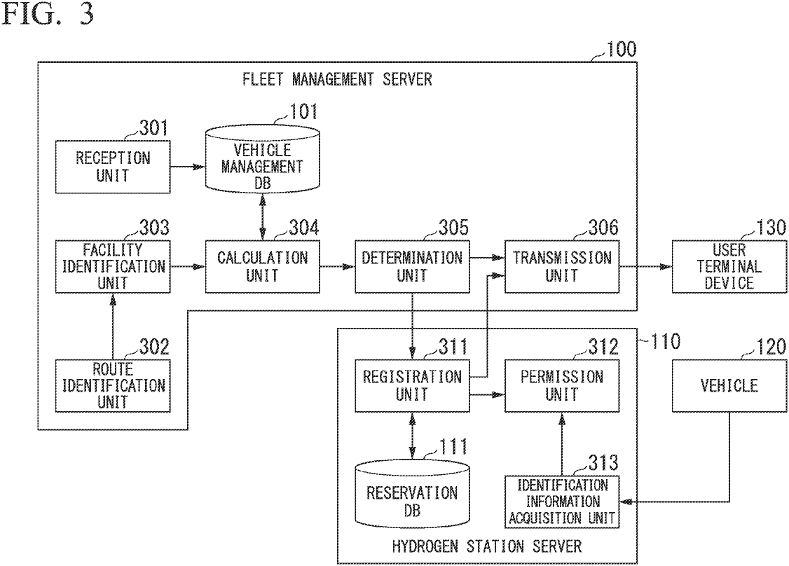

FIG. 3 is a block diagram showing an example of a functional configuration of the hydrogen supply system 1. In FIG. 3, the fleet management server 100 includes a reception unit 301, a route identification unit 302, a facility identification unit 303, a calculation unit 304, a determination unit 305, and a transmission unit 306. Each functional unit is implemented by the CPU 201. That is, the CPU 201 implements functions of each unit by executing the reservation program.

The hydrogen station server 110 includes a registration unit 311, a permission unit 312, and an identification information acquisition unit 313. Each functional unit is implemented by the CPU included in the hydrogen station server 110. That is, the CPU of the hydrogen station server 110 implements functions of each unit by executing a predetermined program.

The functional units (the reception unit 301, the route identification unit 302, the facility identification unit 303, the calculation unit 304, the determination unit 305, and the transmission unit 306) included in the fleet management server 100 are not limited to being included in the fleet management server 100. Similarly, the functional units (the registration unit 311, the permission unit 312, and the identification information acquisition unit 313) included in the hydrogen station server 110 are not limited to being included in the hydrogen station server 110. For example, all of the functional units included in the fleet management server 100 and the functional units included in the hydrogen station server 110 may be included in the fleet management server 100, or may be included in the hydrogen station server 110. Some of the functional units included in the fleet management server 100 may be included in the hydrogen station server 110. Similarly, some of the functional units included in the hydrogen station server 110 may be included in the fleet management server 100.

The vehicle 120 transmits vehicle information to the fleet management server 100 at a predetermined frequency. The vehicle information includes remaining amount information, position information, and vehicle identification information. The remaining amount information is information indicating a remaining amount of hydrogen fuel. The position information is information indicating a current location of a vehicle. The vehicle identification information is information for identifying the vehicle 120. The vehicle identification information includes, for example, a number displayed on a license plate, a number or a symbol written in large letters on a vehicle body of the vehicle 120 for the purpose of identification, and the like. The frequency at which each vehicle transmits the remaining amount information may be a predetermined frequency such as, for example, every few minutes, every few hours, every half day, or once a day.

The reception unit 301 receives the vehicle information transmitted from the vehicle 120 via the communication I/F 203. The received vehicle information is stored in the vehicle management DB 101.

The route identification unit 302 identifies a travel route of the vehicle 120 to a destination. The travel route may be a fixed route or an estimated route. In a case in which the travel route is set as a fixed route, a destination input and a route search are performed by one of the devices. The destination input may be performed by either the vehicle 120 or the user terminal device 130. The route search to the destination may be performed by any of the fleet management server 100, the vehicle 120, and the user terminal device 130.

In a case in which the fleet management server 100 searches for the route, the route identification unit 302 may acquire the destination from either the vehicle 120 or the user terminal device 130 that has received the destination input. Then, the route identification unit 302 searches for the route from a current location of the vehicle 120 to the destination, thereby identifying the searched route as the travel route. In a case in which the route search is performed by either the vehicle 120 or the user terminal device 130, the route identification unit 302 may acquire the route from any device for which the route search has been performed and specify the acquired route as the travel route.

For example, even in a case in which the travel route is a fixed route, it is possible to eliminate the need to input the destination if the vehicle 120 makes a round trip between truck yards, for example. Specifically, the route identification unit 302 may identify a route along which the vehicle 120 always travels as the travel route.

In a case in which the travel route is an estimated route, the route identification unit 302 may estimate the route with the highest possibility of traveling as the travel route on the basis of the current location of the vehicle 120 and the past travel history, for example. The route identification unit 302 may search a route from the current location of the vehicle to the closest hydrogen station in the vicinity and estimate the route as the travel route.

The facility identification unit 303 identifies the hydrogen station located in the vicinity of the travel route of the vehicle 120 to the destination. The vicinity of the travel route includes the current location and the destination, as well as on locations on the route. The facility identification unit 303 may identify a hydrogen station on the travel route or a hydrogen station at the destination. In a case in which there is no hydrogen station on the travel route, the facility identification unit 303 may identify the nearest hydrogen station from the travel route.

The facility identification unit 303 may identify the hydrogen station designated by the user. The designation of the hydrogen station by the user may be received by the vehicle 120 or the user terminal device 130. The facility identification unit 303 may identify the hydrogen station by receiving the received content from the vehicle 120 or the user terminal device 130.

The facility identification unit 303 identifies a hydrogen station within reachable range on the basis of the remaining amount information of the vehicle 120. For example, even if there is a hydrogen station at the destination, the vehicle 120 may not be able to reach the hydrogen station because the remaining amount of hydrogen in the vehicle 120 is already low. For this reason, the facility identification unit 303 identifies the hydrogen station within the reachable range on the basis of the remaining amount of hydrogen fuel in the vehicle 120.

The facility identification unit 303 may prioritize and identify a plurality of hydrogen stations. For example, priorities may be assigned such that, in a case in which the remaining amount of hydrogen fuel in the vehicle 120 is large, a distant hydrogen station may be specified as a high priority hydrogen station, and in a case in which the remaining amount of hydrogen fuel in the vehicle 120 is small, a nearby hydrogen station may be identified as a high priority hydrogen station.

The calculation unit 304 calculates an estimated remaining amount of hydrogen fuel at an arrival time when the vehicle 120 reaches the hydrogen station on the basis of the remaining amount information. The arrival time is obtained by adding a time required to reach the destination and a current time. The time required to reach the destination is obtained by dividing a distance from the current location to the destination by a travel speed of the vehicle 120. The estimated remaining amount of hydrogen fuel at the arrival time is simply a remaining amount at the arrival time and is obtained by dividing the distance from the current location to the destination by fuel efficiency. The calculation unit calculates the arrival time, the time required to reach the destination, and the estimated remaining amount.

The calculation unit 304 calculates an estimated replenishment amount on the basis of the estimated remaining amount. As in the present embodiment, in a case in which the vehicle 120 has a specified tank capacity (5000 g), the calculation unit 304 calculates the estimated replenishment amount “5000 g-(estimated remaining amount)” from the tank capacity and the remaining amount. In a case in which the hydrogen supply system 1 is set to include another vehicle with a tank capacity different from 5000 g, the remaining amount information transmitted from the other vehicle may include information indicating the remaining amount and information indicating the tank capacity.

The determination unit 305 determines whether or not the vehicle 120 needs to be refueled on the basis of the estimated remaining amount calculated by the calculation unit 304. For example, the determination unit 305 may determine that refueling is required if the estimated remaining amount is equal to or less than a threshold. Even if the estimated remaining amount is equal to or less than the threshold, in a case in which there is the next hydrogen station in the vicinity of the travel route to the destination, it may determine that refueling is not required. However, the next hydrogen station is assumed to be within the reachable range with the remaining amount of hydrogen fuel in the vehicle 120.

In a case in which the determination unit 305 determines that refueling is required, the registration unit 311 registers the estimated replenishment amount and the arrival time as a usage reservation at the hydrogen station. At the time of registration of the registration unit 311, the fleet management server 100 makes a registration request to the hydrogen station server 110. The registration request includes vehicle information and estimation information in the vehicle management DB 101, which will be described below.

FIG. 4 is a diagram showing an example of information stored in the vehicle management DB 101. In FIG. 4, the vehicle management DB includes items of “hydrogen station,” “vehicle information,” and “estimation information.” The “hydrogen station” indicates the hydrogen station specified by the facility identification unit 303. Specifically, the “hydrogen station” indicates the name of each hydrogen station, such as a store A and a store B. The item “vehicle information” further includes items of “vehicle identification information,” “remaining amount,” and “position information.” The “vehicle identification information” is vehicle identification information received by the reception unit 301. The “remaining amount” is the remaining amount indicated by the remaining amount information received by the reception unit 301. The “position information” is the current location indicated by the position information received by the reception unit 301.

The item “estimation information” further includes items of “arrival time” and “estimated replenishment amount.” The “Arrival time” is the arrival time calculated by the calculation unit 304. The “estimated replenishment amount” is the estimated replenishment amount calculated by the calculation unit 304.

The fleet management server 100 makes a registration request to the hydrogen station identified by the facility identification unit 303, including the vehicle information and the estimation information. When the registration unit 311 of the hydrogen station server 110 acquires the registration request from the fleet management server 100, it refers to the reservation DB 111 to determine whether or not there is a reservation slot. Here, an example of information stored in the reservation DB 111 will be described with reference to FIG. 5.

FIG. 5 is a diagram showing an example of information stored in the reservation DB 111. FIG. 5 shows the reservation DB 111 of a certain hydrogen station (for example, the store A). In FIG. 5, the reservation DB includes items of “dispenser,” “reservation information,” and “remaining supply amount.” The “dispenser” indicates each dispenser located at the store A. The item “reservation information” further includes “reservation time,” “vehicle identification information,” and “estimated replenishment amount.” The “reservation time” is a time corresponding to the “arrival time” included in the registration request. The “vehicle identification information” is information corresponding to the “vehicle identification information” included in the registration request. The “estimated replenishment amount” is a replenishment amount corresponding to the “estimated replenishment amount” included in the registration request. The “remaining supply amount” is a suppliable remaining amount of hydrogen fuel at the store A.

When the registration unit 311 acquires the registration request from the fleet management server 100, it determines whether or not there is a vacancy in the “arrival time” included in the registration request. The time required for replenishment is, for example, 5 minutes. The registration unit 311 determines whether or not supply of the hydrogen fuel is possible on basis of the “estimated replenishment amount” included in the registration request and the “remaining supply amount” stored in the reservation DB 11. In a case in which positive determination results are obtained in both these two determinations, the registration unit 311 registers the usage reservation in response to the registration request in the reservation DB 111. On the other hand, in a case in a negative determination result is obtained in at least one of these two determinations, the registration unit 311 does not make the usage reservation. When the registration unit 311 registers the usage reservation, it updates the remaining supply amount by subtracting the estimated replenishment amount from the remaining supply amount.

Next, transmission of the usage reservation to the user terminal device 130 when the usage reservation is completed will be described. When the registration unit 311 completes the usage reservation, it transmits usage reservation information indicating the usage reservation to the fleet management server 100. When the transmission unit 306 of the fleet management server 100 receives the usage reservation information, it transmits the usage reservation information to the user terminal device 130 associated with the vehicle 120.

Upon receiving the usage reservation information, the user terminal device 130 outputs the usage reservation information. Outputting the usage reservation information is, for example, outputting the usage reservation indicated by the usage reservation information by display or voice. Upon receiving the usage reservation information, the user terminal device 130 may output a predetermined notification sound indicating that the usage reservation information has been received. The user terminal device 130 may notify the user of this at a predetermined time before the reservation time (for example, 20 minutes before).

The usage reservation is not limited to being output from the user terminal device 130 and may be output from the vehicle 120. Specifically, when the usage reservation is completed, the registration unit 311 may transmit the usage reservation information to the vehicle 120 via the fleet management server 100. The vehicle 120 may output the usage reservation information using an information processing device such as a navigation device.

When the registration unit 311 registers the usage reservation, it may obtain a permission of the user. Specifically, when the usage reservation is possible, the registration unit 311 transmits reply request information for receiving whether or not to confirm the usage reservation to the user terminal device 130 via the fleet management server 100. When the user terminal device 130 receives the reply request information, it receives a reply from the user and transmits the reply result to the registration unit 311 via the fleet management server 100. The registration unit 311 may confirm the registration of the usage reservation in accordance with the received reply result.

Next, permission of refueling at the hydrogen station will be described. The permission unit 312 permits refueling of the vehicle 120 on the basis of the vehicle identification information included in the usage reservation and the vehicle identification information obtained when the vehicle 120 reaches the hydrogen station. The vehicle identification information obtained by reaching the hydrogen station is obtained by the identification information acquisition unit 313. For example, in a case in which the vehicle identification information is a number of a license plate attached to the vehicle 120, the license plate is imaged by a predetermined camera disposed at the hydrogen station. Then, the number (vehicle identification information) can be obtained by image analysis of the imaging result of the camera. That is, the identification information acquisition unit 313 can acquire the vehicle identification information on the basis of the imaging result of the camera installed at the hydrogen station.

The vehicle identification information can also be represented by a code such as a two-dimensional code, for example. The two-dimensional code may be displayed on the user terminal device 130 or attached to the vehicle body of the vehicle 120. Upon arriving at the hydrogen station, the two-dimensional code is read by a predetermined scanner provided at the hydrogen station. Then, the vehicle identification information can be obtained from the reading result of the scanner. That is, the identification information acquisition unit 313 can also acquire the vehicle identification information on the basis of the reading result of the two-dimensional code by the scanner.

The permission of refueling by the permission unit 312 is not limited to usage of the vehicle identification information. For example, a reservation number may be included in the usage reservation information transmitted to the user terminal device 130 when the usage reservation is completed. The reservation number may be displayed as a two-dimensional code. The refueling may be permitted by reading this two-dimensional code with a predetermined scanner provided in the hydrogen station. The reservation number may simply be displayed numerically. In this case, the user may present the number to a store staff so that the store staff can confirm and permit the refueling.

Each functional unit shown in FIG. 3 is realized by executing a program (software) by a hardware processor such as a central processing unit (CPU). Some or all of these constituent elements may be realized by hardware (a circuit unit including circuitry) such as a large scale integration (LSI), an application specific integrated circuit (ASIC), a field-programmable gate array (FPGA), and a graphics processing unit (GPU), or may be realized by software in cooperation with hardware.

### Example of Reservation Processing in Hydrogen Supply System 1

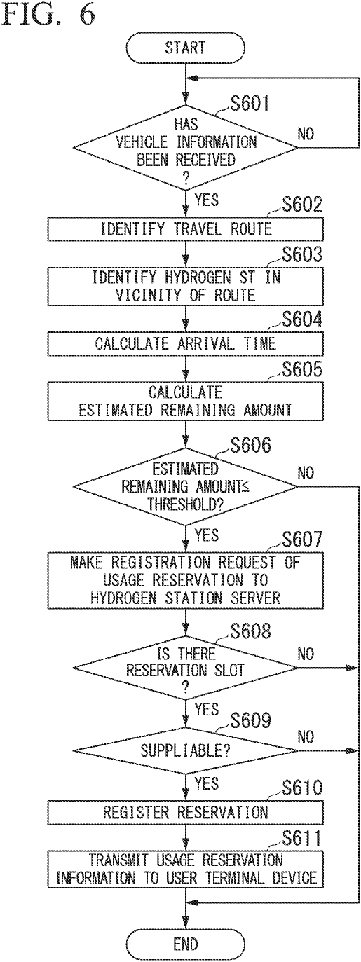

FIG. 6 is a flowchart showing an example of reservation processing in the hydrogen supply system 1. The illustration shows processing focused on a specific vehicle 120. In FIG. 6, the fleet management server 100 determines whether or not vehicle information has been received. The fleet management server 100 waits until the vehicle information is received. Upon receiving the vehicle information, the fleet management server 100 identifies the travel route.

Then, the fleet management server 100 identifies the hydrogen station in the vicinity of the travel route. Next, the fleet management server 100 calculates the arrival time when the vehicle 120 reaches the hydrogen station. Then, the fleet management server 100 calculates the estimated remaining amount at the arrival time. Next, the fleet management server 100 determines whether or not the estimated remaining amount is equal to or less than the threshold.

In a case in which the estimated remaining amount is not equal to or less than the threshold, the fleet management server 100 terminates a series of processing. On the other hand, in a case in which the estimated remaining amount is equal to or less than the threshold, the fleet management server 100 requests the hydrogen station server 110 to register the usage reservation. Next, the hydrogen station server 110 determines whether or not there is a reservation slot.

In a case in which there is no reservation slot, the hydrogen station server 110 terminates the series of processing. In this case, the fleet management server 100 may return to step S603, specify another hydrogen station, and perform the processing of steps S603 to S607.

In a case in which there is a reservation slot, the hydrogen station server 110 determines whether or not the hydrogen fuel can be supplied on the basis of the estimated replenishment amount and the suppliable remaining amount of the hydrogen fuel at the hydrogen station. In a case in which supply of the hydrogen fuel is not possible, the hydrogen station server 110 terminates the series of processing. In this case, the fleet management server 100 may return to step S603, identify another hydrogen station, and perform the processing of steps S603 to S608.

In a case in which supply of the hydrogen fuel is possible, the hydrogen station server 110 registers the usage reservation in the reservation DB 111 in response to the registration request. Then, the fleet management server 100 transmits the usage reservation information to the user terminal device 130 associated with the vehicle 120 and ends the series of processing. Upon receiving the usage reservation information, the user terminal device 130 outputs the usage reservation indicated by the usage reservation information.

### Example of Replenishment Processing Performed by Hydrogen Station Server 110

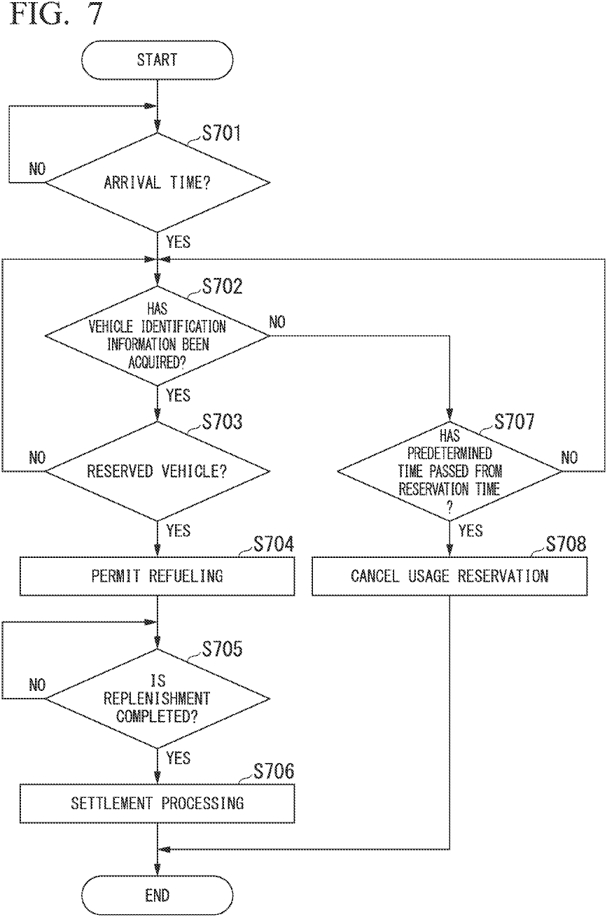

FIG. 7 is a flowchart showing an example of replenishment processing performed by the hydrogen station server 110. The illustration shows processing focused on a specific vehicle 120. In FIG. 7, the hydrogen station server 110 determines whether or not the reservation time stored in the reservation DB 111 has come for a certain vehicle 120. The reservation time here may be a strict reservation time, or may include an error of several minutes before and after.

The hydrogen station server 110 waits until the reservation time comes, and when the reservation time comes, it determines whether or not vehicle identification information has been acquired. When the vehicle identification information is acquired, the hydrogen station server 110 determines whether or not the vehicle has already been reserved. The determination of whether or not the reservation has been made is a determination as to whether or not the acquired vehicle identification information is the vehicle identification information included in the usage reservation at the same time.

In a case in which the vehicle is not a reserved vehicle, the hydrogen station server 110 returns to step S702. On the other hand, in the case of the reserved vehicle, the hydrogen station server 110 permits refueling. Next, the hydrogen station server 110 determines whether or not the refueling has been completed. The hydrogen station server 110 waits until the refueling is completed.

When the refueling is completed, the hydrogen station server 110 performs settlement processing and ends the series of processing. Settlement information generated in the settlement processing is managed by the hydrogen station server 110, transmitted to the fleet management server 100, and managed by the fleet management server 100 as well.

Payments relating to the settlement processing may be made on a one-time replenishment basis, or may be made on a monthly basis. The settlement processing may be performed with a credit card registered in the user terminal device 130, or may be performed with other methods such as cash or electronic money. When the payments are made on a monthly basis, the payments may be made later through a financial institution on the basis of invoices.

On the other hand, in a case in which the vehicle identification information is not acquired in step S702, the hydrogen station server 110 determines whether or not a predetermined time has passed since the reservation time. The predetermined time is, for example, a time until a start time of the next reservation (another vehicle 120) or a time several minutes before the start time.

In a case in which the predetermined time has not passed since the reservation time, the hydrogen station server 110 returns to step S702. In a case in which the predetermined time has passed since the reservation time, the hydrogen station server 110 cancels the usage reservation and terminates the series of processing. In the case of canceling the usage reservation, the hydrogen station server 110 may transmit notification information indicating it to the user terminal device 130. In a case in which the vehicle 120 does not arrive at the reservation time, notification information for urging may be transmitted to the user terminal device 130.

The fleet management server 100 constantly manages a position of the vehicle 120, and the like. For this reason, even if the usage reservation has been registered, in a case in which the vehicle 120 that clearly does not arrive at the hydrogen station at the reservation time is found, the usage reservation may be canceled at the time of finding.

The hydrogen supply system 1 of the embodiment described above calculates the estimated remaining amount of the hydrogen fuel at the arrival time at the hydrogen station on the basis of the remaining amount information received from the vehicle 120. Then, in a case in which the hydrogen supply system 1 determines that refueling of the vehicle 120 is required on the basis of the calculated estimated remaining amount, the estimated replenishment amount based on the estimated remaining amount and the arrival time are registered as the usage reservation at the hydrogen station.

Thus, even if the user does not perform any operation or procedure relating to refueling, the refueling reservation will be made while driving. For this reason, safe driving can be supported, and the user is freed from worrying about a remaining amount of hydrogen and a replenishment location during driving. It is also possible to shorten the user’s waiting time for refueling. Further, at the hydrogen station, since it is possible to know in advance how much amount of supply of hydrogen fuel is required, an amount of hydrogen fuel supplied, an amount of pressure accumulated, and the like can be increased in advance to required amounts. Accordingly, it is possible to inhibit shortage of hydrogen fuel. By generating and accumulating more than a required amount of hydrogen fuel, it is possible to provide the hydrogen fuel to general vehicles that stop by without making a usage reservation. In this way, according to the hydrogen supply system 1 according to the present embodiment, replenishment and provision of hydrogen fuel can be efficiently performed.

The hydrogen supply system 1 according to the present embodiment transmits the usage reservation information indicating the registered usage reservation to the user terminal device 130 and displays the usage reservation on the user terminal device 130. Thus, the user can be notified that the usage reservation has been registered. Accordingly, since the user only needs to arrive at the hydrogen station in time in accordance with the usage reservation, the user can replenish the hydrogen fuel without considering waiting for replenishment. Since the waiting for replenishment can be eliminated, it is possible to inhibit occurrence of a traffic jam at the hydrogen station.

The hydrogen supply system 1 according to the present embodiment permits refueling of the vehicle 120 on the basis of the vehicle identification information included in the usage reservation and the vehicle identification information obtained when the vehicle 120 reaches the hydrogen station. Thus, the hydrogen fuel can be replenished to a target vehicle 120 for which the usage reservation has been registered. In other words, it is possible to prevent replenishment from being performed for a vehicle 120 that has a registered usage reservation but come to be refueled at a time different from a reservation time. Accordingly, the hydrogen fuel can be appropriately provided to each vehicle 120 in accordance with the usage reservation.

As described above, the aspects for carrying out the present invention has been described using the embodiment, but the present invention is not limited to such an embodiment at all, and various modifications and substitutions can be made without departing from the gist of the present invention.

What is claimed is:

1. A hydrogen supply system comprising:
a facility identification unit that identifies a fuel supply facility in the vicinity of a travel route of a vehicle to a destination;
a calculation unit that calculates an estimated remaining amount of hydrogen fuel at an arrival time when the vehicle reaches the fuel supply facility on the basis of remaining amount information indicating a remaining amount of the hydrogen fuel transmitted from the vehicle;
a determination unit that determines whether or not refueling of the vehicle is required on the basis of the estimated remaining amount; and
a registration unit that registers an estimated replenishment amount based on the estimated remaining amount and the arrival time as a usage reservation at the fuel supply facility in a case in which the determination unit determines that the refueling is required.

2. The hydrogen supply system according to claim 1,
wherein a user terminal device associated with the vehicle is provided,
a transmission unit that transmits usage reservation information indicating the usage reservation registered by the registration unit to the user terminal device is provided, and
the user terminal device outputs the usage reservation information.

3. The hydrogen supply system according to claim 1,
wherein the usage reservation includes vehicle identification information that identifies the vehicle, and
a permission unit that permits the refueling of the vehicle on the basis of the vehicle identification information included in the usage reservation and the vehicle identification information obtained when the vehicle reaches the fuel supply facility is provided.

4. A reservation device comprising:
a facility identification unit that identifies a fuel supply facility in the vicinity of a travel route of a vehicle to a destination;
a calculation unit that calculates an estimated remaining amount of hydrogen fuel at an arrival time when the vehicle reaches the fuel supply facility on the basis of remaining amount information indicating a remaining amount of the hydrogen fuel transmitted from the vehicle;
a determination unit that determines whether or not refueling of the vehicle is required on the basis of the estimated remaining amount; and
a registration unit that registers an estimated replenishment amount based on the estimated remaining amount and the arrival time as a usage reservation at the fuel supply facility in a case in which the determination unit determines that the refueling is required.

5. A reservation method that causes a computer used in a hydrogen supply system to execute processing comprising:
identifying a fuel supply facility in the vicinity of a travel route of a vehicle to a destination;
calculating an estimated remaining amount of hydrogen fuel at an arrival time when the vehicle reaches the fuel supply facility on the basis of remaining amount information indicating a remaining amount of the hydrogen fuel transmitted from the vehicle;
determining whether or not refueling of the vehicle is required on the basis of the estimated remaining amount; and
registering an estimated replenishment amount based on the estimated remaining amount and the arrival time as a usage reservation at the fuel supply facility in a case in which it is determined that the refueling is required in the determining.

6. A computer-readable non-transitory storage medium that stores a program that executes processing in a computer used in a hydrogen supply system, the processing comprising:
identifying a fuel supply facility in the vicinity of a travel route of a vehicle to a destination;
calculating an estimated remaining amount of hydrogen fuel at an arrival time when the vehicle reaches the fuel supply facility on the basis of remaining amount information indicating a remaining amount of the hydrogen fuel transmitted from the vehicle;
determining whether or not refueling of the vehicle is required on the basis of the estimated remaining amount; and
registering an estimated replenishment amount based on the estimated remaining amount and the arrival time as a usage reservation at the fuel supply facility in a case in which it is determined that the refueling is required.
